(19) United States
(12) Patent Application Publication
(10) Pub. No.: US 2010/0107585 A1
(43) Pub. Date: May 6, 2010

(54) CUTTING TOOL FOR MOWING SYSTEMS

(76) Inventor: Anthony Farris, Fairfield, VA (US)

Correspondence Address: JAY M. SCHLOFF, 6960 Orchard Lake Road, Suite 315, West Bloomfield, MI, 48322, US

(21) Appl. No.: 12/553,194

(22) Filed: Sep. 3, 2009

Related U.S. Application Data
(60) Provisional application No. 61/111,378, filed on Nov. 5, 2008.

(51) Int. Cl. A01D 34/00

(52) U.S. Cl. 56/13.6

(57) ABSTRACT

A cutting tool for a mowing system for cutting plants is provided. The mowing system includes a driving mechanism capable of being driven by an external shaft. The cutting tool includes a plate member and at least one chain member. The plate member is removably connected to the driving mechanism. The plate member is capable of being rotated by the driving mechanism. Each chain member of the at least one chain member is coupled to the plate member at an end of the each chain member. The at least one chain member is capable of cutting the plants upon rotation of the plate member when the plants come in contact with the at least one chain member.

### CROSS-REFERENCE TO RELATED APPLICATIONS

The present disclosure claims priority under 35 United States Code, Section 119 on the U.S. Provisional Patent Application No. 61/111,378 filed on Nov. 5, 2008 the disclosure of which is incorporated by reference.

### FIELD OF THE DISCLOSURE

The present disclosure generally relates to mowing systems, and more particularly, to a cutting tool to be used with a mowing system for cutting plants.

### BACKGROUND OF THE DISCLOSURE

Mowing systems include equipment that is employed for cutting small plants such as grasses, weeds and bushes. The mowing systems are generally attached to a rear part of a vehicle, such as a tractor. A variety of mowing systems are presently available in market. A conventional mowing system typically includes a body member, a gear mechanism and a cutting tool. The gear mechanism is positioned on a top portion of the body member. The cutting tool of the conventional mowing system is generally positioned on a bottom surface of the body member. The cutting tool is operatively coupled to the gear mechanism. The gear mechanism provides rotational movement to the cutting tool. The cutting tool includes a disc member having blades attached thereto. The blades attached to the disc member rotate due to the rotational movement of the cutting tool. The rotation of the blades results in cutting of plants, which come in contact with the blades. Often the mowing systems are required to be utilized on uneven surfaces or surfaces containing stones and other obstructions, which is generally associated with various drawbacks.

During utilization of the mowing system on uneven surfaces and surfaces containing stones and other obstructions, the stones and other obstructions may collide with the blades of the mowing system. When the stones and other obstructions collide with the blades, the stones and other obstructions may be hurled in various directions. Such hurled stones and other obstructions may pose a threat to individuals present in the area around the mowing system. The hurled stones and other obstructions may also cause considerable damage to the mowing system and various parts thereof (such as the body member and the blades.) Since the blades are composed of a hard material such as an iron alloy, which is not flexible, the blades are very vulnerable to threats posed by stones and other obstructions. Once the blades of the mowing system are damaged, they must be replaced. The replacement of damaged blades incurs a considerable cost. Moreover, the blades are connected to the disc member by a conventional means, for example, nuts and bolts. Such conventional means pose difficulty in their rapid installation and removal. Therefore, the replacement of the blades connected to the disc member may be a tiring and a time consuming activity.

Accordingly, there exists a need for a cutting tool, which should preclude stones and other obstructions from being hurled in various directions, thereby preventing the individuals and the mowing systems, from being hit. Further, the cutting tool should be capable of avoiding drawbacks such as the considerable cost incurred in replacement of the blades of the mowing systems, tiring and time consuming activities of installation and removal of the blades of the mowing system.

### SUMMARY OF THE DISCLOSURE

In view of the foregoing disadvantages inherent in the prior art, the general purpose of the present disclosure is to provide a cutting tool to be used with a mowing system for cutting plants that is configured to include all the advantages of the prior art, and to overcome the drawbacks inherent therein.

Accordingly, an object of the present disclosure is to provide a cutting tool for a mowing system that is capable of cutting plants without hurling stones and other obstructions, thereby preventing individuals, the mowing system and parts thereof for being hit.

Another object of the present disclosure is to provide a cutting tool for a mowing system that is capable of cutting plants, in a safe, convenient, reliable, user friendly, and a cost effective manner.

To achieve the above objects, in an aspect of the present disclosure, a cutting tool for a mowing system for cutting plants is provided. The mowing system includes a driving mechanism which is capable of being driven by an external shaft. The cutting tool includes a plate member and at least one chain member. The plate member is removably connected to the driving mechanism. The plate member is capable of being rotated by the driving mechanism. Each chain member of the at least one chain member is coupled to the plate member at an end of the each chain member. The at least one chain member is capable of cutting the plants upon rotation of the plate member.

This together with the other aspects of the present disclosure, along with the various features of novelty that characterized the present disclosure, is pointed out with particularity in the claims annexed hereto and forms a part of the present disclosure. For a better understanding of the present disclosure, its operating advantages, and the specified object attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, in which:

FIG. 1 illustrates a perspective view of a mowing system for cutting plants, in accordance with an embodiment of the present disclosure;

FIG. 2A is a bottom view of the mowing system illustrating a cutting tool, in accordance with an embodiment of the present disclosure; and

FIG. 2B is an exploded bottom perspective view of the mowing system illustrating the cutting tool, in accordance with an embodiment of the present disclosure.

Like reference numerals refer to like parts throughout the description of several views of the drawings.

### DETAILED DESCRIPTION OF THE DISCLOSURE

For a thorough understanding of the present disclosure, reference is to be made to the following detailed description, including the appended claims, in connection with the above-described drawings. Although the present disclosure is described in connection with exemplary embodiments, the present disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The terms “a” and “an” herein do not denote a limitation of quantity, but rather denote the presence of at least one of the referenced item.

The present disclosure provides a cutting tool to be used with a mowing system for cutting plants. A suitable example of the mowing system may be a “brush hog”. The mowing system may be connected to a vehicle such as a tractor. The vehicle facilitates movement of the mowing system on a ground surface. However, for the purpose of brevity of description, the connection of the mowing system to the vehicle has not been described.

The present disclosure provides the cutting tool to be used with a mowing system for cutting plants. The cutting tool includes a plate member and at least one chain member. The at least one chain member is coupled to the plate member. The at least one chain member rotates with the rotation of the plate member, thereby cutting plants. The at least one chain member bends with it comes in contact with stones or other obstructions. Therefore, the at least one chain member precludes the stones and other obstructions from getting hurled. The at least one member is coupled to the plate member by means of a shackle. The shackle facilitates a quick installation and removal of the at least one chain member on the plate member.

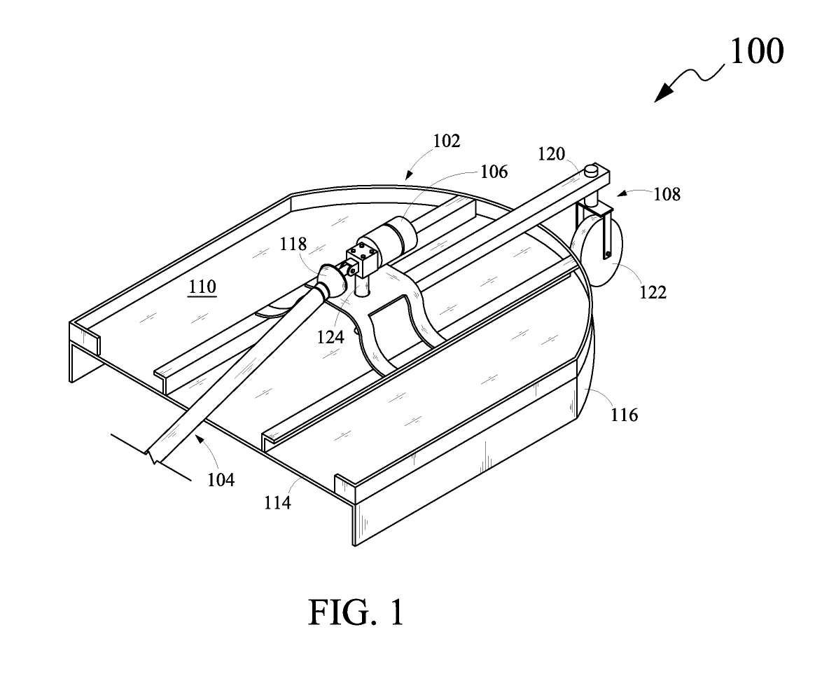

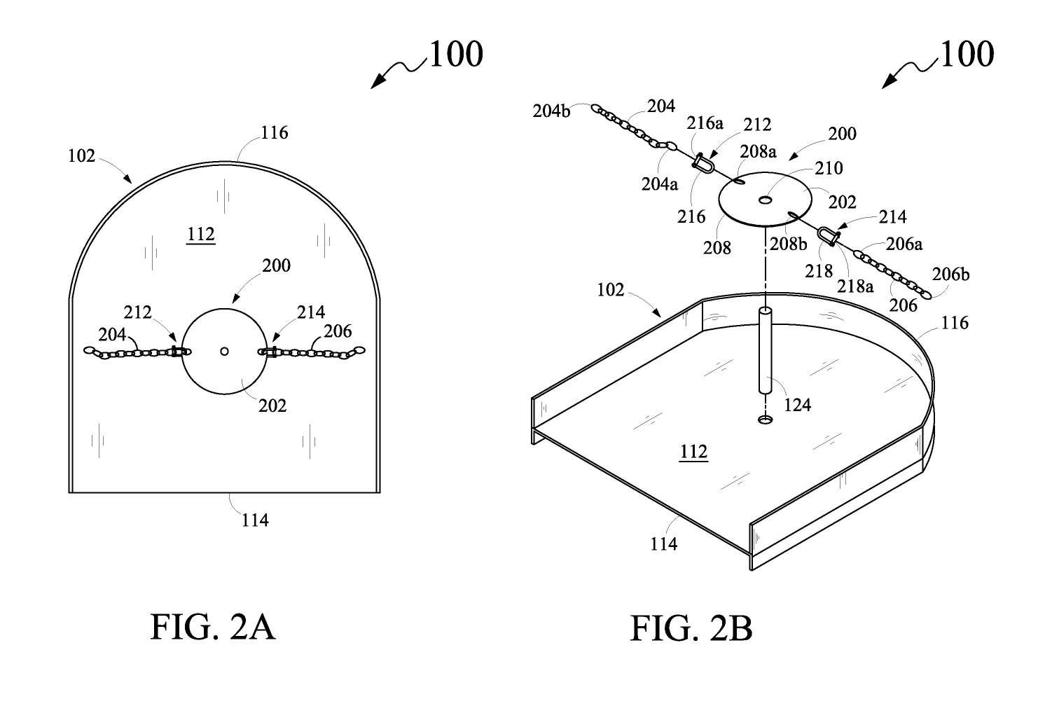

Referring now to FIGS. 1, 2A and 2B, a mowing system 100 including a cutting tool 200 is described, embodying the present disclosure. FIG. 1 depicts a perspective view of the mowing system 100. FIG. 2A is a bottom view of the mowing system 100 illustrating the cutting tool 200. FIG. 2B depicts an exploded bottom perspective view of the mowing system 100 illustrating the cutting tool 200.

The mowing system 100 includes a body member 102, an external shaft, such as a drive shaft 104, a driving mechanism 106, and a wheel system 108. The body member 102 has a top surface 110, a bottom surface 112 (see FIGS. 2A and 2B), a proximal edge portion 114 and a distal edge portion 116. The drive shaft 104 has a first end portion 118 and a second end portion (not shown). The second end portion of the drive shaft 104 may be connected to a vehicle (not shown) such as a tractor. The first end portion 118 of the drive shaft 104 may be connected to the driving mechanism 106. The drive shaft 104 receives a rotational movement from the vehicle and imparts the rotational movement to the driving mechanism 106. The wheel system 108 (shown in FIG. 1) may include a connecting member 120 and at least one wheel, such as a wheel 122. For the sake of brevity of this description, the wheel system 108 is not depicted in the bottom views of the mowing system 100, i.e., in FIGS. 2A and 2B. The connecting member 120 is configured to connect the wheel 122 to the body member 102 of the mowing system 100. The wheel 122 facilitates movement of the mowing system 100 on a ground surface.

The driving mechanism 106 may be disposed on the top surface 110 of the body member 102. The driving mechanism 106 is capable of transmitting rotational movement to the cutting tool 200 (see FIGS. 2A and 2B). In an embodiment of the present disclosure, a shaft 124 extends from the driving mechanism 106 and outwardly from the bottom surface 112 of the body member 102. The shaft 124 is configured to connect the cutting tool 200 to the driving mechanism 106. The shaft 124 is capable of transmitting rotational movement to the cutting tool 200.

The cutting tool 200 includes a plate member 202 and at least one chain member, such as a chain member 204 and a chain member 206. The plate member 202 is capable of being removably connected to the driving mechanism 106 through the shaft 124. The plate member 202 may be circular in shape. Although the plate member 202 is depicted having a circular shape, however it should be evident to a person skilled in the art that the plate member 202 may be of any shape, such as oval shape or polygonal shape.

The plate member 202 includes a plurality of slots on a peripheral edge portion 208 of the plate member 202, such as a slot 208a and a slot 208b. An end portion 204a of the chain member 204 may be connected to the slot 208a. Similarly, an end portion 206a of chain member 206 may be connected to the slot 208b. Although, only two slots 208a and 208b, and corresponding chain members 204 and 206 are shown in FIGS. 2A and 2B, however it would be apparent to those ordinary skilled in the art that the plate member 202 may include fewer or more number of slots and chain members corresponding to the slots. End portions 204b and 206b of the chain members 204 and 206, respectively are free ends.

In an embodiment of the present disclosure the end portion 204a of the chain member 204 is connected to the slot 208a by means of a shackle, such as a shackle 212. Similarly, the end portion 206a of the chain member 206 is connected to the slot 208b by means of a shackle 214. Each of the shackles 212 and 214 include a U-shaped section capable of being locked by a locking pin. As depicted in FIG. 2B, the shackle 212 includes a U-shaped section 216 capable of being locked by a locking pin 216a. Similarly, the shackle 214 includes a U-shaped section 218 capable of being locked by a locking pin 218a. The U-shaped section 216 is inserted through the slot 208a, and the end portion 204a of the chain member 204 is received into the U-shaped section 216. Further, the locking pin 216a is used to lock the U-shaped section 216. Similarly, the U-shaped section 218 is received into the slot 208b, and the end portion 206a of the chain member 206 is received into the U-shaped section 218. Further, the locking pin 218a is used to lock the U-shaped section 218.

In an embodiment, the plate member 202 has an opening 210 at a substantial central portion of the plate member 202. The opening 210 facilitates the connection of the plate member 202 with the driving mechanism 106. More specifically, the shaft 124 extending from the driving mechanism 106 is received into the opening 210 on the plate member 202. The rotation of the shaft 124 causes the plate member 202 to rotate. In an embodiment of the present disclosure, each of the plate member 202 and the at least one chain member is composed of iron. In another embodiment of the present disclosure, each of the plate member 202 and the at least one chain member are composed of a metallic alloy, such as steel.

In operation, the mowing system 100 is connected to the vehicle. The vehicle carries the mowing system 100 over a surface, such as a garden. The vehicle delivers a rotational movement to the driving mechanism 106. The driving mechanism 106 further transfers the rotational movement to the plate member 202 thereby causing the plate member 202 to rotate. The rotation of the plate member 202 causes the chain members 204 and 206 to rotate, thereby cutting plants that come in contact with the chain members 204 and 206. During the utilization of the mowing system 100 on a surface containing stones and other obstructions, the chain members 204 and 206 may bend with respect to one another when the stones and other obstructions come in contact with the chain members 204 and 206, as the chain members 204 and 206 are flexible in configuration. Therefore, stones and other obstructions that come in contact with the chain members 204 and 206 are prevented from getting hurled in various directions.

The present disclosure provides a cutting tool such as the cutting tool 200 to be used with a mowing system such as the mowing system 100 for cutting plants coming in the contact of the cutting tool 200. The cutting tool includes a plate member and at least one chain member. The plate member may be circular in shape having a peripheral edge. The at least one chain member is coupled to the peripheral edge portion of the plate member. The at least one chain member and the peripheral edge portion of the plate member may be connected by means of a shackle. The at least one chain member rotates with the rotation of the plate member, thereby cutting plants. A plurality of chain members may bend when coming in contact with stones or other obstructions during cutting the plants. Therefore, the at least one chain member precludes the stones and other obstructions from being hurled or thrown. The shackle facilitates quick installation and un-installation of the at least one chain member on the plate member.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A cutting tool for a mowing system for cutting plants, the mowing system comprising a driving mechanism capable of being driven by an external shaft, the cutting tool comprising:
a plate member removably connected to the driving mechanism, the plate member capable of being rotated by the driving mechanism; and
at least one chain member, an end of each of the at least one chain member coupled to the plate member, the at least one chain member capable of cutting the plants in contact with the at least one chain member upon rotation of the plate member.

2. The cutting tool of claim 1, wherein each chain member of the at least one chain member is removably coupled to the plate member through a shackle.

3. The cutting tool of claim 1, wherein the plate member includes a plurality of slots on a peripheral edge portion of the plate member, each slot of the plurality of slots capable of receiving a shackle to couple a chain member of the at least one chain member to the plate member.

4. The cutting tool of claim 1, wherein each of the plate member and the at least one chain member is composed of steel.

5. The cutting tool of claim 1, wherein each of the plate member and the at least one chain member is composed of iron.

6. The cutting tool of claim 1, wherein the plate member is circular in shape.
